(19) United States
(12) Patent Application Publication
(10) Pub. No.: US 2016/0238279 A1
(43) Pub. Date: Aug. 18, 2016

(54) METHODS OF PROCESSING A FURNACE

(71) Applicant: Corning Incorporated, Corning, NY (US)

(72) Inventors: Byung Chul Jeon, Chungcheongnam-do (KR); Heung Chol Shin, Chungcheongnam-do (KR)

(21) Appl. No.: 14/621,917

(22) Filed: Feb. 13, 2015

(51) Int. Cl. F24H 9/06; B23P 6/00; B23P 19/04

(52) U.S. Cl. CPC F24H 9/06; B23P 19/04; B23P 6/00; F27D 2001/0059

(57) ABSTRACT

Methods of processing a furnace include the step (I) of supporting the furnace with a support member configured to span across and beyond a footprint of a mounting area. A support surface outside of the footprint is configured to support at least one pair of opposite end portions of the support member such that the furnace is suspended over the mounting area. The method may further include the step (II) of levitating the opposite end portions of the support member over the support surface on a cushion of fluid, and the step (III) of moving the furnace together with the support member relative to the support surface while the opposite end portions of the support member are levitated over the support surface with the cushion of fluid.

### FIELD

The present disclosure relates generally to methods of processing a furnace and, more particularly, to methods of processing a furnace including moving a furnace together with a support member relative to a support surface.

### BACKGROUND

It is known to provide a furnace that may include a melting vessel configured to receive batch material and process the batch material into a glass melt. In some examples, the glass melt may be further processed into a glass ribbon for subsequent division into a plurality of glass sheets.

### SUMMARY

The following presents a simplified summary of the disclosure in order to provide a basic understanding of some example aspects described in the detailed description.

In accordance with one aspect, a method of processing a furnace comprises the step (I) of supporting the furnace with a support member configured to span across and beyond a footprint of a mounting area. A support surface outside of the footprint is configured to support at least one pair of opposite end portions of the support member such that the furnace is suspended over the mounting area. The method further includes the step (II) of levitating the opposite end portions of the support member over the support surface on a cushion of fluid, and the step (III) of moving the furnace together with the support member relative to the support surface while the opposite end portions of the support member are levitated over the support surface with the cushion of fluid.

In one example of the aspect, during step (I), the furnace is positioned within the footprint such that the furnace is suspended over the mounting area. In one particular example, step (III) moves the furnace to a position outside of the footprint. In another particular example, after step (III), the method further comprises the step of removing the support member. For instance, in one example, the step of removing the support member includes the step of lifting the furnace off the support member. In another particular example, after step (III), the method further comprises the step of servicing the furnace.

In another example of the aspect, step (III) comprises moving the furnace from a position outside the footprint to a position within the footprint such that the furnace is suspended over the mounting area. In one particular example, after step (III), the method further comprises the step of removing the support member and then placing the furnace on a support structure within the mounting area. In another example, the furnace comprises a glass melting furnace and the method further comprises the step of operably connecting the glass melting furnace to a downstream glass manufacturing apparatus after placing the furnace on the support structure. In still another example, the step of removing the support member comprises lifting the furnace off the support member. In yet another example, the step of placing the furnace includes lowering the furnace to the support structure. In one particular example, the step of lowering the furnace includes the steps of lifting the furnace with a jack, removing a set of elevation spacers, and lowering the furnace with the jack. In another example, the furnace is assembled at a location outside the footprint. In still another example, the furnace is serviced at a location outside the footprint.

In still another example of the aspect, step (III) moves the furnace by guiding the furnace along a predetermined path. In one particular example, step (III) includes guiding the support member along the predetermined path with a guide rail.

In yet another example of the aspect, the cushion of fluid comprises a cushion of air.

The aspect can be provided alone or in combination with one or any combination of the examples of the aspect discussed above.

### BRIEF DESCRIPTION OF THE DRAWINGS

These and other features, aspects and advantages of the present disclosure are better understood when the following detailed description is read with reference to the accompanying drawings, in which:

FIG. 1 is a schematic view of a fusion down-draw apparatus configured to draw a glass ribbon including the step of removing a furnace and installing a furnace;

FIG. 2 is a schematic partial cross-section of a mounting area for the furnace of FIG. 1;

FIG. 3 illustrates a schematic sectional view of the furnace within the mounting area along line 3-3 of FIG. 2;

FIG. 4 illustrates the furnace of FIG. 3 with the furnace being lifted off a support structure by a jack such that feet of a base of the furnace are spaced from the support structure;

FIG. 5 illustrates the lifted furnace of FIG. 4 with at least one first elevation spacer positioned within the space between the feet of the base and the support structure;

FIG. 6 illustrates the lifted furnace of FIG. 5 being supported by the at least one first elevation spacer with at least one first jack spacer positioned over a retracted jack;

FIG. 7 illustrates further lifting of the furnace of FIG. 6 by extending the jack such that the feet of the base of the furnace are spaced from the underlying elevation spacers;

FIG. 8 illustrates the further lifted furnace of FIG. 7 with at least one second elevation spacer positioned within the space between the feet of the base and the first elevation spacer;

FIG. 9 illustrates the further lifted furnace of FIG. 8 with at least one second jack spacer positioned within a space over the first jack spacer;

FIG. 10 illustrates still further lifting the furnace and positioning a support member underneath the feet of the base of the furnace;

FIG. 11 illustrates the furnace of FIG. 10 being lowered onto the support member with the jack and jack spacers removed;

FIG. 12 is a top view of the furnace being supported by the support member along line 12-12 of FIG. 11;

FIG. 13 is a schematic cross-section of the furnace suspended over the mounting area along line 13-13 of FIG. 12;

FIG. 14 is an enlarged view of taken at view 14,15 of FIG. 13 illustrating a support surface outside of a footprint of the mounting area supporting an end portion of the support member;

FIG. 15 is similar to FIG. 14 but schematically illustrates levitating the end portion of the support member over the support surface on a cushion of fluid;

FIG. 16 is a schematic top view of illustrating the step of guiding the support member along a predetermined path with a guide rail;

FIG. 17 is a schematic side view of the furnace with the support member;

FIG. 18 is a schematic side view of the furnace with support member of FIG. 17 with a jack lifting the furnace off the support member;

FIG. 19 illustrates a side view of FIG. 18 wherein the furnace has been lowered onto fluid support bearings;

FIG. 20 illustrates the furnace of FIG. 19 being levitated by the fluid support bearings on a cushion of fluid over the support surface for moving to another location;

FIG. 21 illustrates the step of lifting the furnace off the fluid support bearings at the desired location such that the fluid support bearings can be removed; and

FIG. 22 illustrates the fluid support bearings being removed and the furnace being lowered and thereafter placed on the support surface at the desired location for construction or servicing of a furnace.

### DETAILED DESCRIPTION

Apparatus and methods will now be described more fully hereinafter with reference to the accompanying drawings in which example embodiments of the disclosure are shown. Whenever possible, the same reference numerals are used throughout the drawings to refer to the same or like parts. However, this disclosure may be embodied in many different forms and should not be construed as limited to the embodiments set forth herein.

Aspects of the disclosure include methods of processing a furnace. Furnaces of the disclosure may be provided for a wide range of applications to heat gases, liquids and/or solids. In just one example, furnaces of the present disclosure are described with reference to a glass melting furnace configured to melt batch material into a glass melt although other types of furnaces may be provided in further examples. Furthermore, although the illustrated example provides a furnace configured to change the phase of a solid (e.g., batch) into a liquid (e.g., glass melt), other furnaces of the disclosure may be provided to simply heat a gas, liquid and/or solid without a phase change or with only a partial phase change between gas, liquid and/or solid. In some examples, a furnace may be configured to sinter a green body into ceramic, such as a honeycomb green body into a honeycomb ceramic substrate. In further examples, the furnace may be designed to carry out a heat treatment of an article. For example, an article may be heat treated to change a microstructure of the article.

Methods of the disclosure may process the furnace in a wide variety of ways. For instance, the furnace may be processed by moving the furnace relative to another structure (e.g., placing the furnace on a support structure within a mounting area, removing the furnace from a support structure within a mounting area, moving the furnace relative to a support surface, etc.). In further examples, the furnace may be processed by assembling the furnace (e.g., originally assembling, etc.), servicing the furnace (e.g., repairing the furnace, reconstructing the furnace, conducting routine maintenance, etc.), replacing the furnace, operating the furnace (e.g., using the furnace to heat gases, liquids and/or solids), or other processing techniques.

Methods of the disclosure may process furnaces with a heating vessel (e.g., melting vessel) to heat material. Optionally, the furnaces may include one or more further components such as heating elements, thermal management devices, electronic devices, electromechanical devices, support structures or other components to facilitate operation of the particular furnace.

In some examples, the furnace can comprise the illustrated glass melting furnace 105 that can include a melting vessel 106. In addition to the melting vessel 106, the glass melting furnace 105 can optionally include one or more further components such as heating elements (e.g., burners) configured to heat batch material to convert solid batch material into a glass melt. In further examples, the glass melting furnace 105 may include thermal management devices (e.g., insulation components) configured to reduce heat lost from a vicinity of the melting vessel. In still further examples, the glass melting furnace 105 may include electronic devices and/or electromechanical devices configured to facilitate melting of the batch material into a glass melt. Still further, the glass melting furnace 105 may include support structures (e.g., support chassis, support member, etc.) or other components.

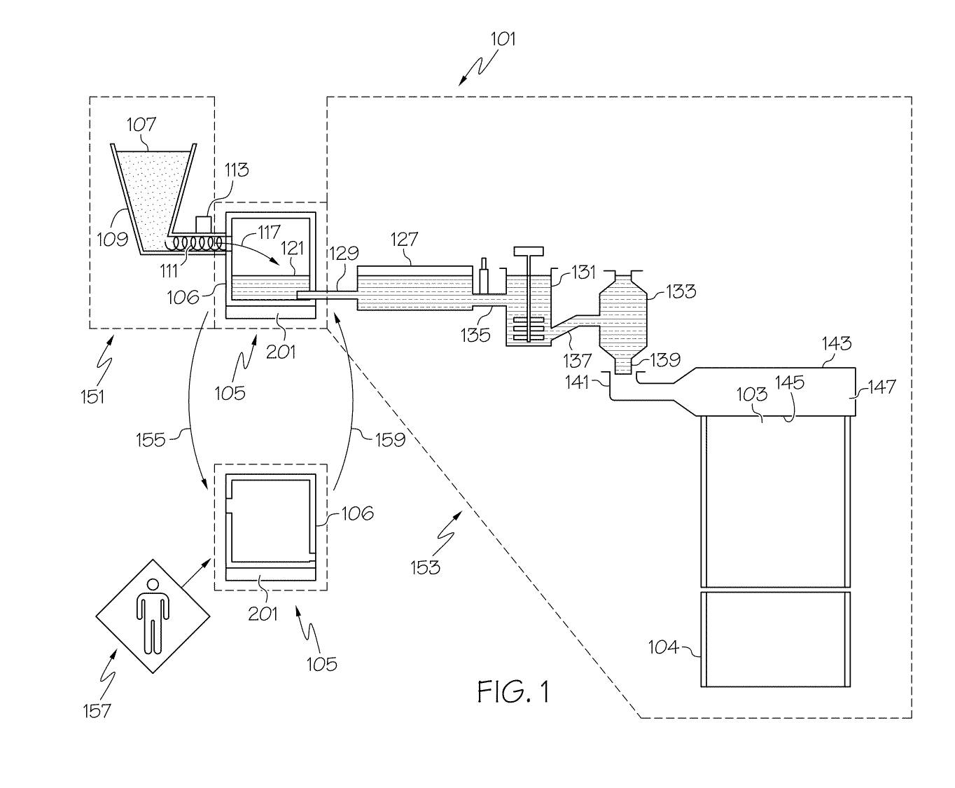

In some examples, the glass melting furnace may be incorporated as a component of a glass manufacturing apparatus configured to fabricate a glass ribbon although the glass melting furnace may be incorporated in other glass manufacturing apparatus in further examples. In some examples, the glass melting furnace of the disclosure may be incorporated as a component of a glass manufacturing apparatus comprising a slot draw apparatus, float bath apparatus, down-draw apparatus, up-draw apparatus, press-rolling apparatus or other glass ribbon manufacturing apparatus. By way of example, FIG. 1 schematically illustrates the glass melting furnace 105 being incorporated as a component of a fusion down-draw apparatus 101 for fusion drawing a glass ribbon 103 for subsequent processing into glass sheets 104.

The glass manufacturing apparatus (e.g., the fusion down-draw apparatus 101) can optionally include an upstream glass manufacturing apparatus 151 represented schematically by broken lines that is positioned upstream relative to the glass melting furnace 105. In some examples, a portion or the entire upstream glass manufacturing apparatus 151 may be incorporated as part of the glass melting furnace 105.

As shown in the illustrated example, the upstream glass manufacturing apparatus 151 can include a storage bin 109, a batch delivery device 111 and a motor 113. The storage bin 109 may be configured to store a quantity of batch material 107 that can be fed into the melting vessel 106 of the glass melting furnace 105, as indicated by arrow 117. In some examples, a batch delivery device 111 can be powered by a motor 113 configured to deliver a predetermined amount of batch material 107 from the storage bin 109 to the melting vessel 106. In further examples, the motor 113 can power the batch delivery device 111 to introduce batch material 107 at a controlled rate based on a sensed level of glass melt downstream from the melting vessel 106. The batch material 107 within the melting vessel 106 can thereafter be heated to form a glass melt 121.

The glass manufacturing apparatus (e.g., the fusion down-draw apparatus 101) can also optionally include a downstream glass manufacturing apparatus 153 represented schematically by broken lines that is positioned downstream relative to the glass melting furnace 105. In some examples, a portion of the downstream glass manufacturing apparatus 153 may be incorporated as part of the glass melting furnace 105. For instance, the first connecting conduit 129 discussed below, or other portions of the downstream glass manufacturing apparatus 153, may be incorporated as part of the glass melting furnace 105.

The downstream glass manufacturing apparatus 153 can include a first conditioning station such as a fining vessel 127, located downstream from the melting vessel 106 and coupled to the melting vessel 106 by way of the above-referenced first connecting conduit 129. In some examples, the glass melt 121 may be gravity fed from the melting vessel 106 to the fining vessel 127 by way of the first connecting conduit 129. For instance, gravity may act to drive the glass melt 121 to pass through an interior pathway of the first connecting conduit 129 from the melting vessel 106 to the fining vessel 127. Within the fining vessel 127, bubbles may be removed from the glass melt 121 by various techniques.

The downstream glass manufacturing apparatus 153 can further include a second conditioning station such as a glass melt stirring chamber 131 that may be located downstream from the fining vessel 127. The glass melt stirring chamber 131 can be used to provide a homogenous glass melt composition, thereby reducing or eliminating cords of inhomogeneity that may otherwise exist within the fined glass melt exiting the fining vessel. As shown, the fining vessel 127 may be coupled to the glass melt stirring chamber 131 by way of a second connecting conduit 135. In some examples, the glass melt 121 may be gravity fed from the fining vessel 127 to the glass melt stirring chamber 131 by way of the second connecting conduit 135. For instance, gravity may act to drive the glass melt 121 to pass through an interior pathway of the second connecting conduit 135 from the fining vessel 127 to the glass melt stirring chamber 131.

The downstream glass manufacturing apparatus 153 can further include another conditioning station such as a delivery vessel 133 that may be located downstream from the glass melt stirring chamber 131. The delivery vessel 133 may condition the glass melt 121 to be fed into a forming device. For instance, the delivery vessel 133 can act as an accumulator and/or flow controller to adjust and provide a consistent flow of the glass melt 121 to a forming vessel 143. As shown, the glass melt stirring chamber 131 may be coupled to the delivery vessel 133 by way of a third connecting conduit 137. In some examples, glass melt 121 may be gravity fed from the glass melt stirring chamber 131 to the delivery vessel 133 by way of the third connecting conduit 137. For instance, gravity may act to drive the glass melt 121 to pass through an interior pathway of the third connecting conduit 137 from the glass melt stirring chamber 131 to the delivery vessel 133.

The downstream glass manufacturing apparatus 153 can further include a downcomer 139 and the above-referenced forming vessel 143. The downcomer 139 can be positioned to deliver the glass melt 121 from the delivery vessel 133 to an inlet 141 of the forming vessel 143. The glass ribbon 103 may then be fusion drawn off a root 145 of a forming wedge 147 of the forming vessel 143 and subsequently separated into the glass sheets 104 by a glass separation apparatus (not shown).

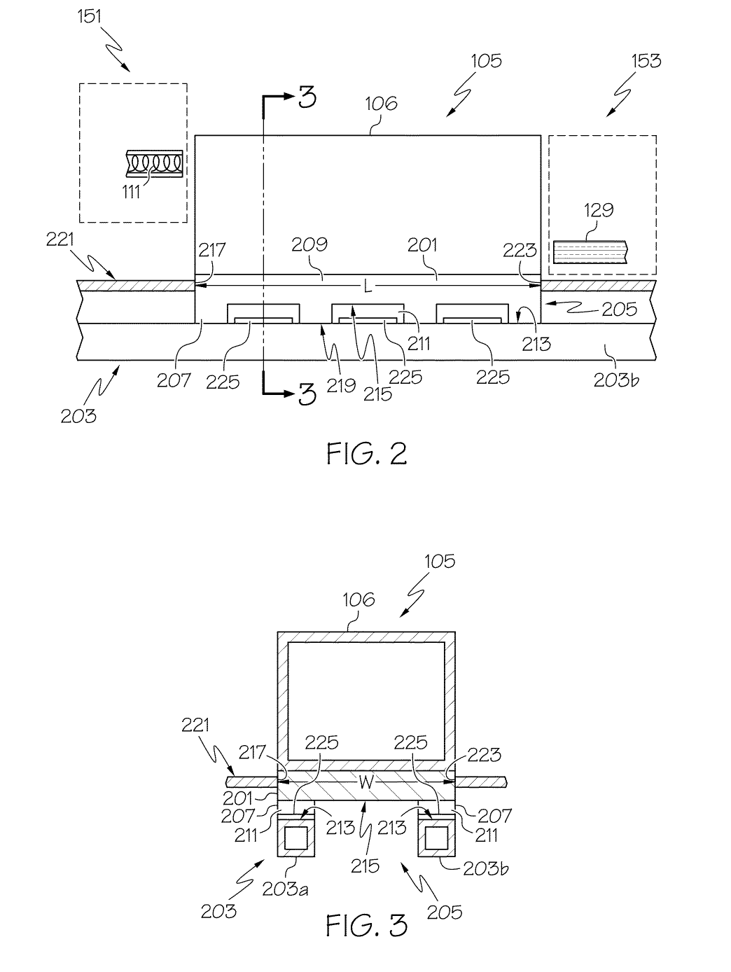

FIG. 1 illustrates the glass melting furnace 105 being incorporated as a component of the fusion down-draw apparatus 101. The glass melting furnace 105 can include a base 201 configured to support the melting vessel 106. As shown, the base 201 can be a separate structure that is mounted to the melting vessel 106 although the base 201 may be incorporated as an integral component of the melting vessel 106 in further examples. As shown in FIGS. 2 and 3, the base 201 may be placed on a support structure 203 within a mounting area 205. The base 201 can support the melting vessel 106 such that the weight of the molten glass and/or batch material within the melting vessel 106 can be supported by the underlying support structure 203 with the base 201.

The support structure 203 can comprise one or more support elements, such as the illustrated support beams 203a, 203b shown in FIG. 3. The support structure 203 is configured to support the weight of the glass melting furnace 105 while the base 201 of the glass melting furnace 105 is placed, and even mounted, to the support structure 203. The support structure 203 may be configured to support not only the weight of the glass melting furnace 105, but also the weight of the batch material and/or glass melt within the melting vessel 106 during operation. In some examples the support structure 203 may be mounted to the foundation of a building or other mount configured to support the weight of the loaded glass melting furnace 105. The support structure 203 may be positioned within the mounting area 205 and, as shown, can optionally be recessed at an elevation below an adjacent support surface 221. Although not shown, in further examples, the mounting area 205 may be located at the support surface 221 or elevated above the support surface 221. For instance, while FIGS. 2 and 3 illustrate the upper surface 213 of the support structure 203 being positioned at an elevation that is lower than an elevation of the support surface 221, in further examples, the upper surface 213 may be flush with the support surface 221 or even positioned at an elevation that is higher than the elevation of the support surface 221.

The support surface 221, in some examples may comprise a surface of a floor (e.g., clean room) adjacent to the mounting area 205. The support surface 221 may be configured to support the weight of the glass melting furnace 105 that is not loaded with batch material and/or glass melt while the support structure 203 within the mounting area 205 may be configured to support the weight of the glass melting furnace 105 in addition to batch material and/or glass melt that may be housed within the melting vessel 106 during operation of the glass melting furnace 105.

The base 201 can comprise a wide range of configurations. In some examples, the base 201 may comprise a framework or other structural configuration designed to support the weight of the melting vessel 106 loaded with batch material and/or glass melt. As illustrated, the base 201 can include a plurality of feet 207 designed to space an upper portion 209 of the base 201 relative to the support structure 203. Indeed, in some examples, the upper portion 209 may be spaced by the feet 207 to define an opening 211 between the upper surface 213 of the support structure 203 and a lower surface 215 of the upper portion 209.

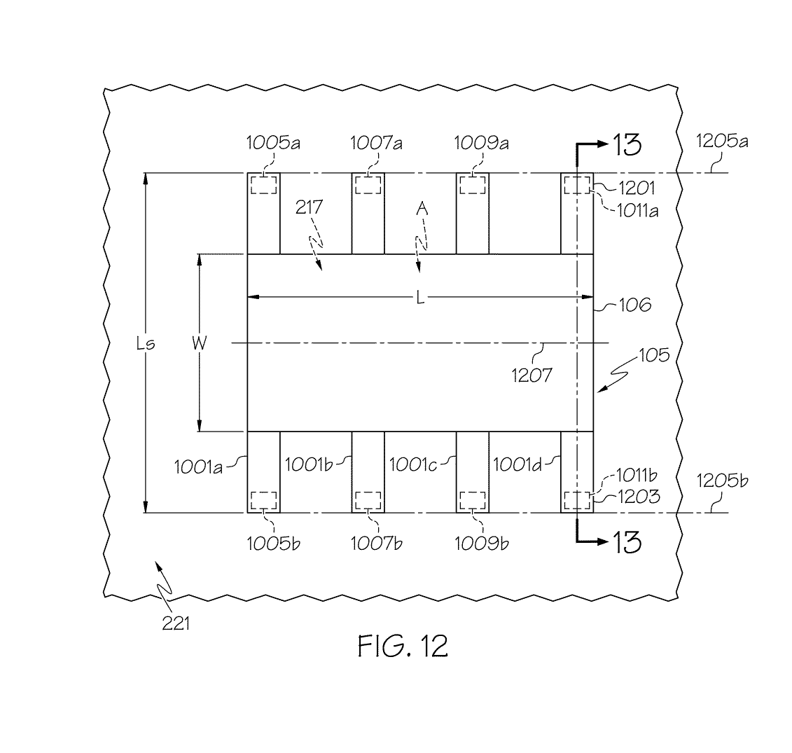

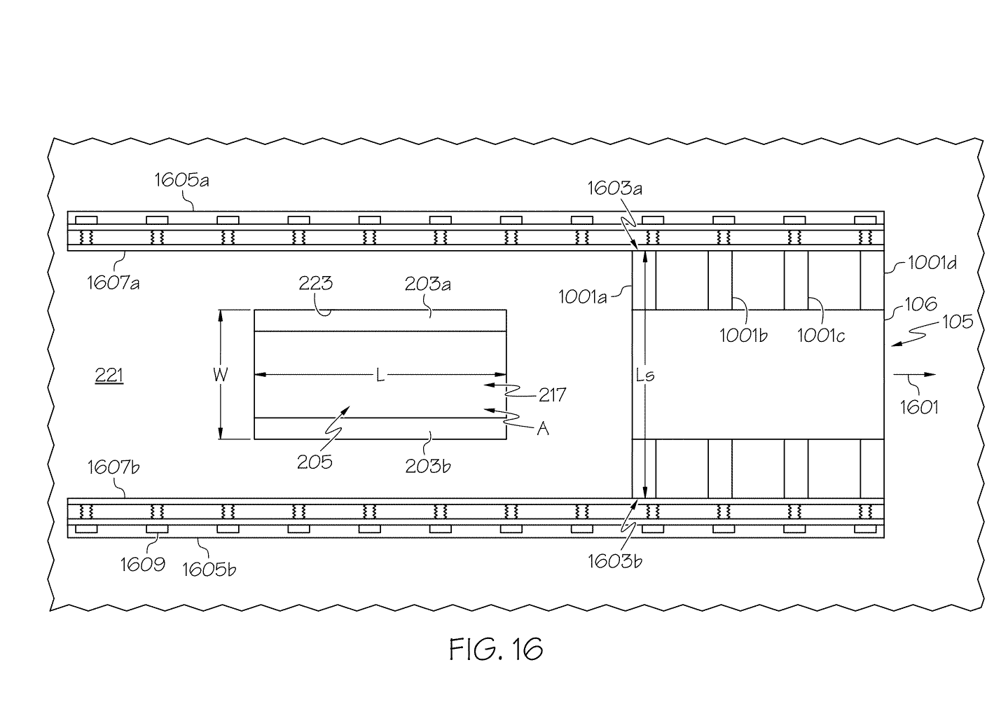

As shown in FIG. 11, the mounting area 205 can include a footprint 217 (represented by broken lines) with an area “A” (see FIG. 12) extending along a plane “P” perpendicular to a direction of gravity “G”. The area “A” and footprint 217 are shown in the upper plan view of FIG. 16 and are also hidden and represented by the broken lines in the upper plan view of FIG. 12. As demonstrated by the view line 12-12 in FIG. 11, the footprint 217 can be viewed in the direction of gravity “G” wherein the plan view of the area “A” of the footprint 217 is shown in FIGS. 12 and 16.

The area “A” of the footprint 217 can provide the clearance necessary to allow the base 201 to reach below a support surface 221 to be placed on the support structure 203. Moreover, as shown in FIG. 11, the area “A” of the footprint 217 further allows the base 201 to be vertically lifted off the support structure 203 to locate lower surfaces 219 of the feet 207 at an elevation higher than the elevation of the support surface 221. The footprint 217 can be circumscribed by a periphery of an opening 223 in the support surface 221. As illustrated, in some examples, the footprint 217 can optionally include a rectangular shape with a length “L” (see FIGS. 2, 12 and 16) and a width “W” (see FIGS. 3, 12, 13 and 16) wherein the area “A” of the rectangular footprint 217 can be the product of the length “L” and the width “W” (i.e., A=L×W). Although not shown, the footprint may include other shapes such as polygonal shapes with three or more sides, circular shapes, elliptical shapes and/or otherwise curvilinear shapes depending on the application and/or configuration of the furnace.

In some examples, there may be a desire to process the furnace 105 by moving the furnace 105 to a location outside of the footprint 217 of the mounting area 205. Movement of the furnace 105 to a location outside of the footprint 217 of the mounting area 205 is represented schematically by arrow 155 in FIG. 1. Once moved, as indicated by arrow 155, the furnace may be serviced (e.g., manually as indicated by reference number 157, automatically service, or otherwise). Servicing may be carried out to repair the furnace, reconstruct the furnace, conduct routine maintenance or otherwise service the furnace. Servicing in this respect may further include replacing the furnace. Moving the furnace 105 to a location outside of the footprint 217 of the mounting area 205 can significantly reduce the complexity of the servicing process and can thereby reduce the time necessary for servicing the furnace 105. Consequently, the cost of labor and/or loss of productivity resulting from the process of servicing the furnace 105 can be significantly reduced by moving the furnace 105 to the location outside of the footprint 217 of the mounting area 205 to service the furnace.

The method of moving the furnace 105 can begin by removing a significant amount of the glass melt 121 from the melting vessel 106. For instance, as shown in FIG. 3, the glass melt 121 may be substantially or completely emptied from the interior of the melting vessel 106. As such, the interior of the melting vessel 106 may be substantially free from solids and/or liquids that may otherwise add significant weight to the furnace 105. In some examples, the furnace 105 may also be disengaged from other components such as the upstream glass manufacturing apparatus 151 and/or the downstream glass manufacturing apparatus 153. Indeed, as shown in FIG. 2, the batch delivery device 111 may be disconnected from the furnace 105 to disengage the upstream glass manufacturing apparatus 151 from the furnace 105. As further shown, the first connecting conduit 129 may be disconnected from the furnace 105 to disengage the downstream glass manufacturing apparatus 153 from the furnace 105.

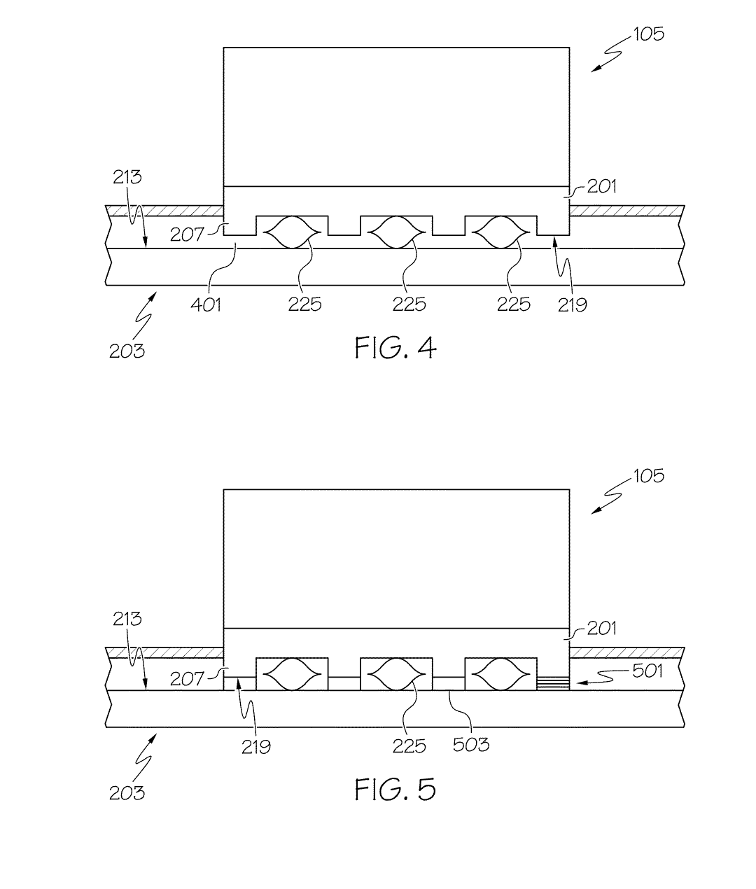

In one example, the method of moving the furnace 105 can include the step of lifting the furnace off of the support structure 203. Lifting can be achieved in a wide variety of ways. For instance, a lifting winch may include a lifting member (e.g., lifting cables) attached to lifting eyelets of the base 201 to lift the furnace 105 off of the support structure 203. In further examples, lifting members (e.g., lifting forks) may be inserted below the base 201 to lift the furnace 105 off of the support structure 203. In further examples, lifting may be carried out with a jack. In some examples, a mechanical jack may be used wherein mechanically linked members may be pivoted relative to one another to lift the furnace 105 off the support structure 203. In further examples, a hydraulic jack using an incompressible fluid (e.g., heavy oil) may be used to lift the furnace 105 off of the support structure 203. In the illustrated example, a plurality of pneumatic jacks 225 may be positioned within the respective openings 211. In the illustrated example, six pneumatic jacks 225 may be used with three jacks associated with each support beam 203a, 203b. In further examples, any number of jacks may be used in a wide range of alternative configurations. As shown in FIG. 4, the method of lifting the furnace 105 off the support structure 203 can include inflating the pneumatic jacks 225 wherein the base 201 is elevated such that a space 401 is provided between the lower surfaces 219 of the feet 207 and the upper surface 213 of the support structure 203.

In some examples, a single lifting stroke of the jack may be adequate to sufficiently lift the furnace 105 to a desired elevation. In further examples, there may be a desire to further lift the furnace 105 to a higher elevation than can be achieved by a single stroke of the pneumatic jacks 225. For instance, multiple jack arrangements may be used to further lift the furnace. As discussed with initial reference to FIG. 5, the same set of jacks 225 may be used together with jack spacers and elevation spacers to further lift the furnace 105 to a higher elevation than can be achieved by a single stroke of the pneumatic jacks 225.

As shown in FIG. 5, a first plurality of elevation spacers 501 may be stacked on one another to form a first elevation spacer stack within each space 401 between the lower surfaces 219 of the respective feet 207 and the upper surface 213 of the support structure 203. Alternatively, as shown, a single first elevation spacer 503 may be provided that fills a portion or substantially the entire space 401. While providing a single spacer may reduce the time necessary to fill at least a portion of the space 401, the plurality of spacers may allow more precise matching of the effective spacer height to the actual height of the space 401, thereby locking in a maximum elevation achieved by a single lifting stroke of the pneumatic jacks 225.

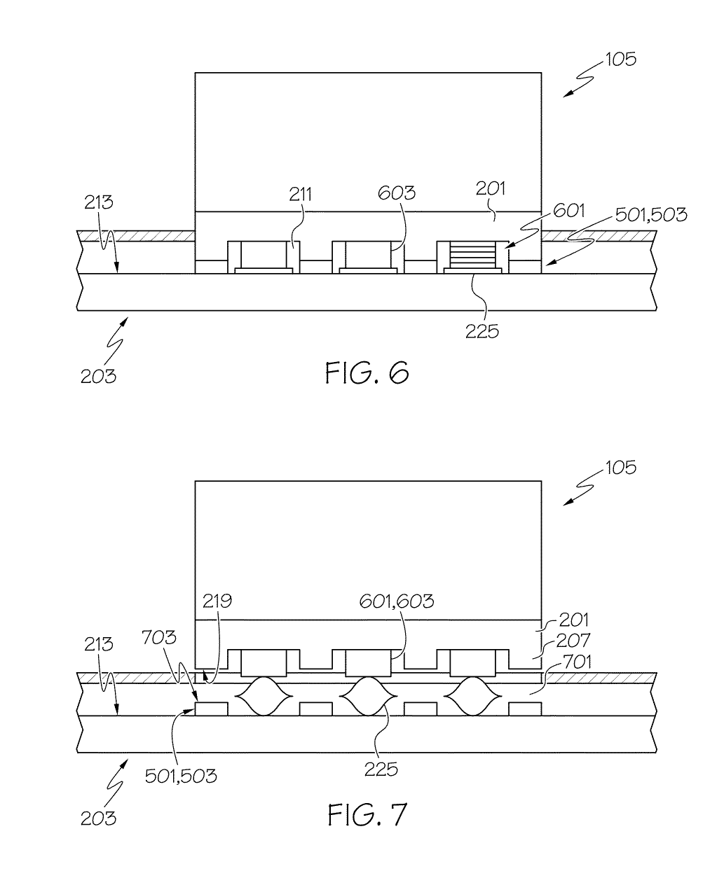

As shown in FIG. 6, the pneumatic jacks 225 may be deflated such that the weight of the furnace 105 is supported by the first elevation spacers 501, 503. A first set of jack spacers (e.g., a plurality of jack spacers 601 and/or a single jack spacer 603) may then be positioned over the deflated pneumatic jacks 225 within the openings 211. As shown in FIG. 7, the pneumatic jacks 225 may be inflated again such that the base 201 is elevated by a second stroke of the pneumatic jacks 225. The second stroke of the pneumatic jacks 225 provides another space 701 between the lower surfaces 219 of each foot 207 and the upper surface 703 of the respective first elevation spacers 501, 503.

In still further examples, there may be a desire to still further lift the furnace 105 to yet an even higher elevation than can be provided by two lifting strokes of the jack. In one example, at least one additional elevation spacer may be provided to facilitate even further lifting of the furnace 105 with the same jack. For instance, as shown in FIG. 8, a plurality of second elevation spacers 801 may be stacked on one another to form a second elevation spacer stack that fills the space 701 between the lower surfaces 219 of the feet 207 and the upper surface 703 of the first elevation spacers 501, 503. Alternatively, as shown, a single second elevation spacer 803 may be provided that fills a portion or substantially the entire space 701.

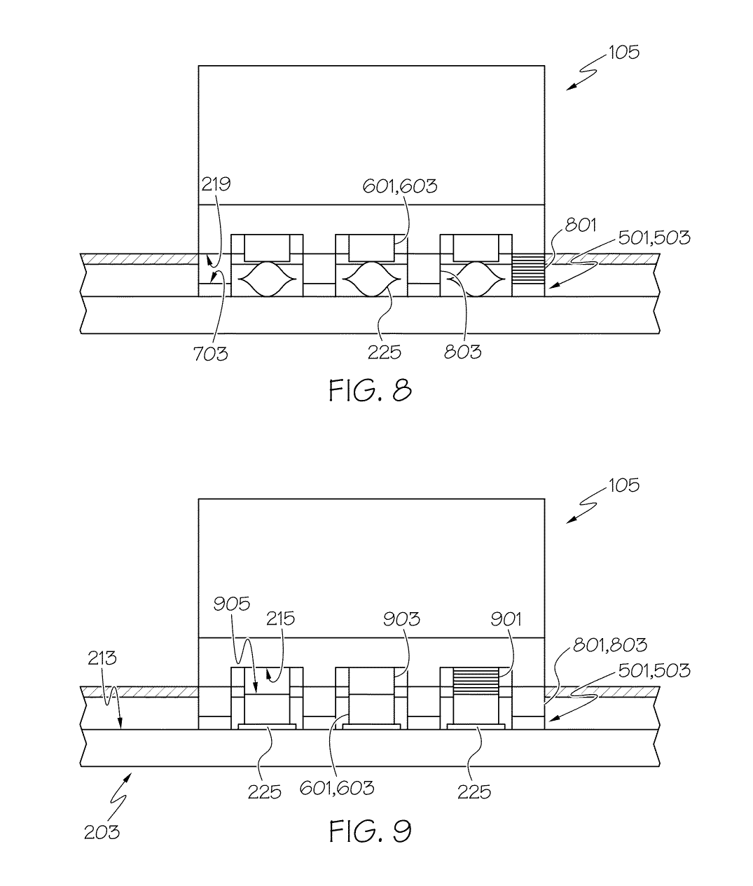

As shown in FIG. 9, the pneumatic jacks 225 may be deflated such that the weight of the furnace 105 is supported by the first elevation spacers 501, 503 and the second elevation spacers 801, 803. A second set of jack spacers (e.g., a plurality of second jack spacers 901 and/or a single jack spacer 903) may then be positioned within a space between an upper surface 905 of the first set of jack spacers 601, 603 and the lower surface 215 of the upper portion 209.

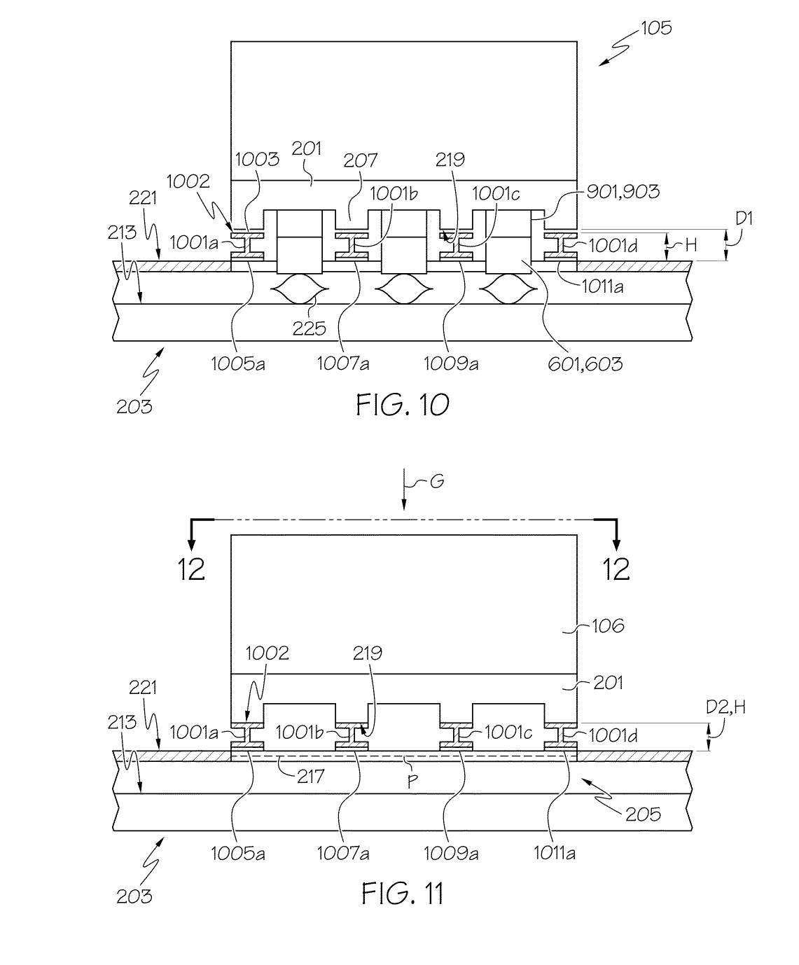

As shown in FIG. 10, the pneumatic jacks 225 may be inflated again such that the base 201 is elevated by a third stroke of the pneumatic jacks 225. The third stroke of the pneumatic jacks 225 provides further elevation such that the lower surfaces 219 of the feet 207 are a distance D1 above the elevation of the support surface 221. As further shown in FIG. 10, the first elevation spacers 501, 503 and the second elevation spacers 801, 803 can be removed and replaced with a support member such as the plurality of support members 1001a, 1001b, 1001c, 1001d. Although four separate support members are illustrated, the support member may comprise a single or any number of support members in further examples. Although the support members are illustrated as separate support beams, the support member can comprise one or more support members that are connected (e.g., integrally connected, removably connected) to one another. In one example, the support member can comprise a support frame. Each of the illustrated support members 1001a, 1001b, 1001c, 1001d can comprise an I Beam, i.e., a beam including a cross-section in the shape of an “I” as illustrated in FIGS. 10-11. Although not shown, the support members may comprise tubular beams or other configurations. The support members can comprise steel or other material, wherein the configuration and material of the support members may be designed to withstand the stress associated with supporting the furnace.

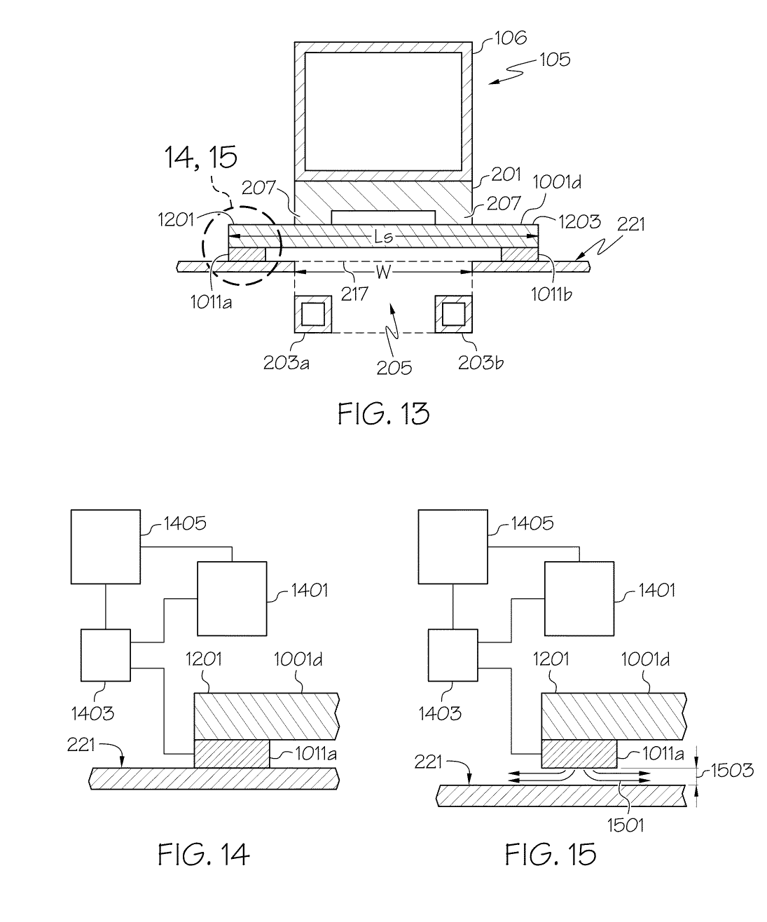

Regardless of the configuration of the support member, the support member is configured to span across and beyond the footprint 217 of the mounting area 205. For instance, the support member can include a length that is greater than a dimension of the footprint. By way of example, each of the illustrated support members 1001a, 1001b, 1001c, 1001d is configured to span across and beyond the footprint 217 of the mounting area 205. For instance, as best shown in FIGS. 12 and 13, one example can provide the support members 1001a, 1001b, 1001c, 1001d with a length “Ls” that is greater than the width “W” of the footprint 217 of the mounting area 205 such that each of the support members 1001a, 1001b, 1001c, 1001d spans across and beyond the footprint 217 of the mounting area 205.

As each support member may span across and beyond the footprint 217, opposite end portions 1201, 1203 of each support member 1001a, 1001b, 1001c, 1001d can be positioned over the support surface 221. Furthermore, a fluid support bearing (e.g., air support bearing, liquid support bearing, vapor support bearing, etc.) may be positioned between each opposite end portion 1201, 1203 of each support member and the support surface 221 outside of the footprint 217. For instance, as shown in FIG. 10 and in hidden lines in FIG. 12, the first end portion 1201 of each of the support members 1001a, 1001b, 1001c, 1001d can be provided with a respective fluid support bearing 1005a, 1007a, 1009a, 1011a positioned between respective first end portions 1201 and the support surface 221 outside of the footprint 217. Likewise, as further shown in hidden lines in FIG. 12, the second end portion 1203 of each of the support members 1001a, 1001b, 1001c, 1001d can be provided with a respective fluid support bearing 1005b, 1007b, 1009b, 1011b positioned between respective second end portions 1203 and the support surface 221 outside of the footprint 217. As can be appreciated by FIGS. 10-12, the fluid support bearings are configured to support the weight of the support members 1001a, 1001b, 1001c, 1001d on the support surface 221.

As shown in FIG. 10, the furnace 105 can be lifted to an elevation wherein the lower surfaces 219 of the feet 207 are positioned a first distance “D1” from the support surface 221. The first distance “D1” can be greater than the combined height “H” of the support members and fluid support bearings such that the support members may be easily placed in proper position relative to one another and/or relative to the furnace 105. Indeed, a space 1003 exists between an upper surface 1002 of the support members and the lower surface 219 whereby the weight of the furnace 105 is not supported by the support members.

While in the position shown in FIG. 10, the support members can be easily moved relative to one another and relative to the furnace since the support members to not support the weight of the furnace. As such, the support members may be oriented in a proper position relative to one another. In some examples, the support members 1001a, 1001b, 1001c, 1001d may be positioned substantially parallel to one another although the support members may be angled with respect to one another in further examples. In further examples, the support members may be equally spaced from one another although alternative spacing arrangements may be desired based on the weight distribution of the furnace. Furthermore, with reference to FIG. 12, the support members may be arranged such that the first end portions 1201 are aligned with one another along a first linear alignment axis 1205a while the second end portions 1203 are also aligned along a second linear alignment axis 1205b. Aligning the end portions along the respective linear alignment axes 1205a, 1205b can help guide a predetermined movement of the furnace as discussed more fully below.

In further examples, the support members 1001a, 1001b, 1001c, 1001d may be oriented at a desired predetermined position relative to the furnace 105. For example, as shown, the length “Ls” of the support members may be centered along the width “W” of the furnace 105. Indeed, in the illustrated example, a central axis 1207 of the furnace 105 can be centered between the linear alignment axes 1205a, 1205b such that each alignment axis 1205a, 1205b is spaced an equal distance from the central axis 1207. Centering the support members can help evenly distribute load between the opposed end portions 1201, 1203 of each support member. In further examples, the elongated axis of the support members (e.g., one, a plurality of, or all of the support members) along the length “Ls” can be perpendicular to the central axis 1207 of the furnace 105. Although the support member(s) may be positioned at alternative angles, positioning the support members such that the elongated axis of the support members are perpendicular to the central axis 1207 can help stabilize the support members during movement of the furnace, thereby minimizing the chance of inadvertent repositioning of the support members relative to one another and/or relative to the furnace.

Once the support members 1001a, 1001b, 1001c, 1001d are properly positioned relative to one another and/or relative to the furnace 105, the pneumatic jacks 225 may be deflated and removed together with the jack spacers. Once deflated, the furnace 105 can be placed on the support members 1001a, 1001b, 1001c, 1001d such that the support members support the weight of the furnace 105. Indeed, as shown in FIG. 11, the lower surfaces 219 of the feet 207 can be placed on the upper surface 1002 of the support members 1001a, 1001b, 1001c, 1001d such that the distance “D2” from the lower surfaces 219 of the feet 207 to the support surface 221 is equal to the combined height “H” of the support members and the fluid support bearings.

As best shown in FIG. 13, once the jacks 225 are deflated and removed, the support members support the weight of the furnace 105 while the furnace is suspended over the mounting area 205. Indeed, a central portion of the length “Ls” of the support members are loaded with the weight of the furnace 105 that is supported at the opposite end portions 1201, 1203 by respective fluid support bearings (e.g., 1011a, 1011b shown in FIG. 13) on the support surface 221 located outside of the footprint 217.

Consequently, any of the methods of the present disclosure can include a method of processing the furnace 105 (e.g., glass melting furnace, etc.) that includes the step of supporting the furnace 105 with the support member (e.g., support members 1001a, 1001b, 1001c, 1001d) configured to span across and beyond the footprint 217 of the mounting area 205, wherein the support surface 221 outside of the footprint 217 is configured to support at least one pair of opposite end portions 1201, 1203 of the support member such that the furnace 105 is suspended over the mounting area 205. As shown, the furnace is positioned within the footprint 217 such that the furnace 105 is suspended over the mounting area 205. Indeed, at least a portion of the furnace 105 is positioned within a vertical projection of the footprint 217 and is therefore positioned within the vertical footprint.

There may be a desire to move the furnace 105 together with the support member over the support surface 221. For instance, in one example, referring to FIG. 16, there may be a desire to move the furnace 105 together with the support structure in a direction 1601 along the support surface 221. The fluid support bearings, which may, for example be air bearings using air as a working fluid, may be used to help reduce or eliminate sliding friction with the support surface 221. Indeed, the fluid support bearings 1005a,b, 1007a,b, 1009a,b, and 1011a,b may be used to levitate the opposite end portions 1201, 1203 of the support members 1001a, 1001b, 1001c, 1001d over the support surface 221 on a cushion of fluid, such as air.

FIGS. 14 and 15 schematically demonstrate features of an example fluid support bearing that may be used in accordance with aspects of the disclosure. The example fluid support bearing may be an air bearing, although other types of fluid bearings may be used. By way of illustration, the fluid support bearing 1011a is discussed below with the understanding that similar or identical constructions may be used with any or all of the other fluid support bearings. As shown, a fluid manifold 1403 may selectively place a source 1401 of pressurized fluid in fluid communication with the fluid support bearing 1011a. The source 1401 of pressurized fluid can comprise a pump, a cylinder of a compressor, such as an air compressor or other source of pressurized fluid. A controller 1405 may be used to operate the source 1401 of pressurized fluid and/or the fluid manifold 1403 to provide the fluid support bearing 1011a with a desired level of pressurized fluid at a desired time. As shown in FIG. 15, once activated, a pressurized stream of fluid generates a cushion of fluid 1501 that levitates the bottom surface of the fluid support bearing 1011a and the corresponding end portion 1201 of the support member 1001d a distance 1503 from the support surface 221. The distance 1503 can be within a range of from about 1 mm to about 4 mm, such as from about 1 mm to about 3 mm, such as from about 2 mm to about 3 mm.

As discussed above, methods of processing the furnace 105 can include the step of levitating the opposite end portions of the support member over the support surface on a cushion of fluid. The cushion of fluid reduces or prevents a friction force with the support surface 221 that would otherwise resist movement of the furnace together with the support member relative to the support surface 221.

In alternative embodiments, the opposite end portions of the support member can be supported over the support surface by placing the opposite ends on wheeled devices or any other form of roller or rollers. For example, in certain embodiments, the opposite ends of the support member can be supported over the support surface by placing the opposite ends on wheeled trucks configured to roll over rails positioned on the support surface.

As shown in FIG. 16, the method of processing the furnace 105 can also include the step of moving the furnace 105 together with the support member (e.g., support members 1001a, 1001b, 1001c, 1001d) relative to the support surface 221 while the opposite end portions 1201, 1203 of the support members are levitated over the support surface 221 with the cushion of fluid 1501. In one example, an operator can push or pull the furnace 105 or the support member in the direction 1601 to promote movement of the furnace in the direction 1601. For instance, the operator can manually push or pull the furnace or may use a material handling vehicle or other device to facilitate movement of the furnace.

As further shown in FIG. 16, the method can move the furnace 105 to a position outside of the footprint 217. Indeed, the furnace is shifted away from the opening 223 in the support surface 221. In one example the furnace can be guided along a predetermined path. For instance, a guiding mechanism such as tongue and groove mechanism, guide channels or other configurations may be used as a guiding mechanism. In the illustrated example, the guiding mechanism includes guide rails 1607a, 1607b extending along a predetermined path that extends along direction 1601. The guide rails can each comprise a bearing surface configured to extend along the respective alignment axes 1205a, 1205b (discussed with respect to FIG. 12 above) to help guide a predetermined movement of the furnace 105 along the direction 1601. Indeed, the bearing surfaces of the guide rails 1607a, 1607b can abut outer ends 1603a, 1603b of the opposite end portions 1201, 1203 of the support members 1001a, 1001b, 1001c, 1001d to guide the furnace 105 along the path in direction 1601 without wandering off the guide path. In some examples, the distance between the guide rails 1607a, 1607b can be fine-tuned to approximate the length “Ls” of the support members to provide a more exact travel path sufficient for the furnace 105. In one example, adjustment screws 1609 may be adjustably connected to mounting brackets 1605a, 1605b that are secured to the support surface 221. The relative distances between the guide rails 1607a, 1607b may be adjusted by way of the adjustment screws.

Once the furnace 105 is positioned outside of the footprint 217, the method may optionally further process the furnace by conducting a step of servicing the furnace. The furnace may be serviced by repairing the furnace, replacing the furnace, reconstructing the furnace, conducting routine maintenance or conducting other servicing techniques.

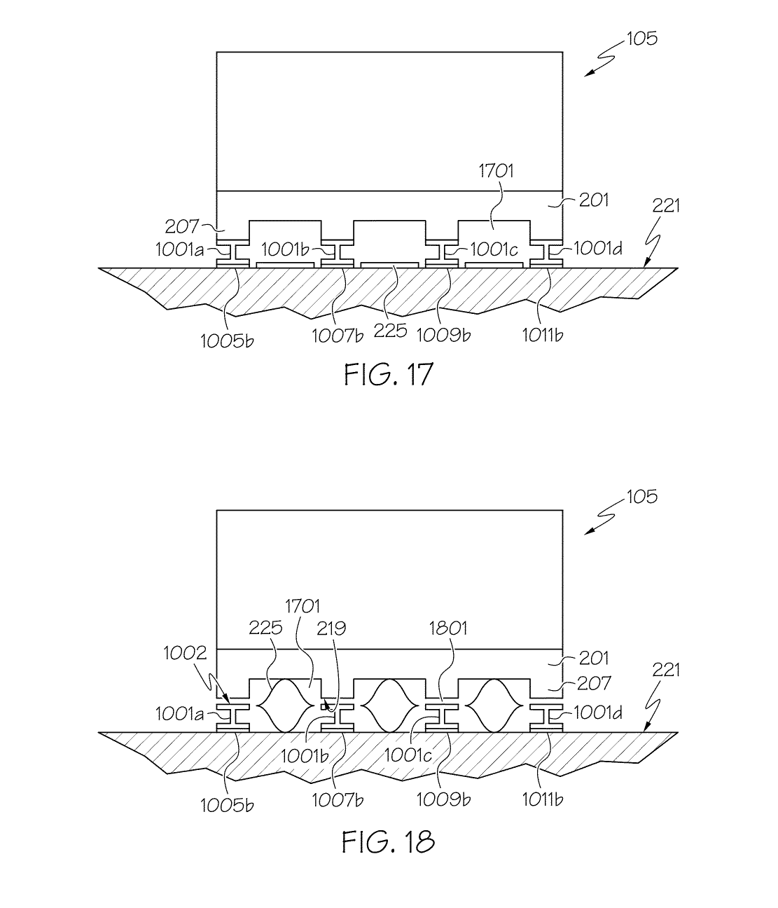

Alternatively, before servicing, the method may include the optional step of removing the support member. The support member may be removed in a wide variety of ways. For instance, the step of removing the support member can include the step of lifting the furnace off the support member. Lifting configurations discussed with respect to lifting the furnace off of the support structure 203 discussed above may be incorporated to facilitate lifting of the furnace 105 for the purpose of removing the support members 1001a, 1001b, 1001c, 1001d. As shown in FIG. 17, in one example, pneumatic jacks 225 may be positioned within space 1701 and thereafter used to lift the furnace off the support member, either alone (as shown) or in combination with jack spacers. Indeed, as shown in FIG. 18, the pneumatic jacks 225 may be inflated within the space 1701 to provide a space 1801 between the lower surface 219 of the feet 207 and the upper surface 1002 of the support members 1001a, 1001b, 1001c, 1001d.

After lifting the furnace 105 as shown in FIG. 18, both the pneumatic jacks 225 and the fluid support bearings 1005a,b, 1007a,b, 1009a,b, and 1011a,b may be removed before deflating and removing the pneumatic jacks 225 as sown in FIG. 22. Optionally, the furnace may then be serviced by repairing the furnace, reconstructing the furnace, replacing the furnace, conducting routine maintenance or conducting other servicing techniques.

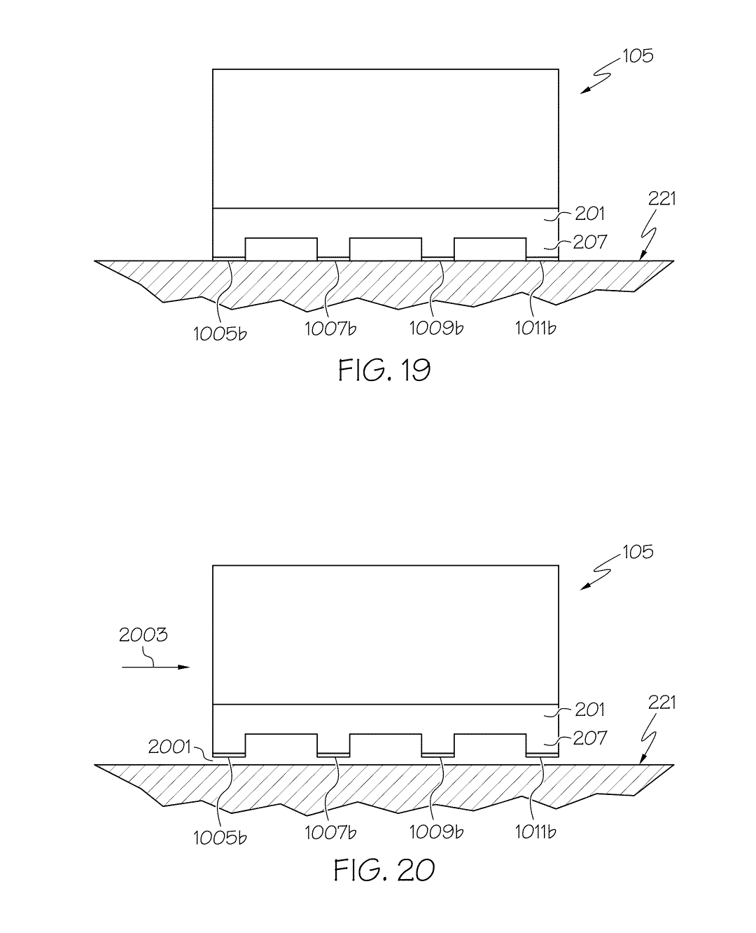

Alternatively, if further movement of the furnace 105 is necessary, the support members 1001a, 1001b, 1001c, 1001d may be removed and the fluid support bearings 1005a,b, 1007a,b, 1009a,b, and 1011a,b may be repositioned directly underneath the feet 207 before the furnace is serviced. The pneumatic jacks 225 can then be deflated and removed, as shown in FIG. 19, such that the feet 207 of the base 201 are supported directly by the fluid support bearings 1005a,b, 1007a,b, 1009a,b, and 1011a,b. Removing the support members 1001a, 1001b, 1001c, 1001d prior to further moving the furnace 105 may be desired in applications where the furnace 105 is required to maneuver about obstacles when moving the furnace 105. For instance, without the support member, the furnace 105 may be easily moved through a doorway into another room.

To conduct further movement with the fluid support bearings, as shown in FIG. 20, the fluid support bearings may again be activated to produce a cushion of fluid 2001 between the fluid support bearings and the support surface 221 to reduce or prevent friction between the fluid support bearing and the support surface 221. As described above, an operator can thereafter similarly apply force to cause movement of the furnace 105 in direction 2003.

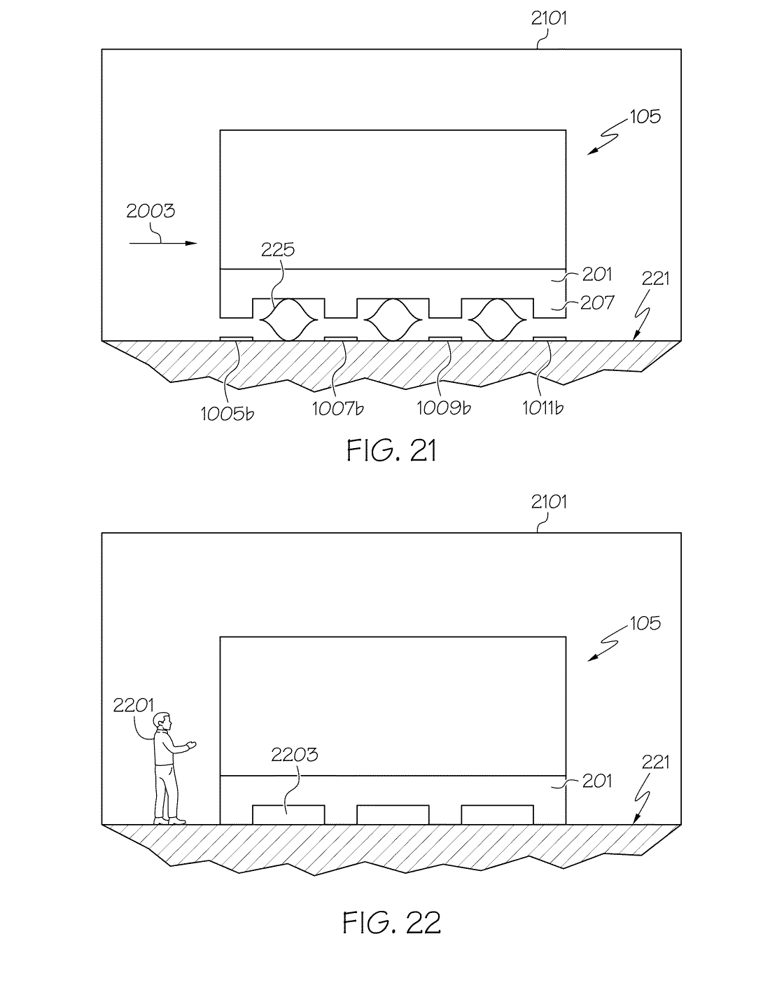

The furnace 105 may eventually reach a desired location 2101 such as a servicing room, clean room, or other location. Optionally, as shown in FIG. 21, the pneumatic jacks 225 may then be inflated to allow removal of the fluid support bearings 1005a,b, 1007a,b, 1009a,b, and 1011a,b. As shown in FIG. 22, the pneumatic jacks 225 may thereafter be deflated and removed such that the feet 207 of the base 201 directly engage the support surface 221 to support the furnace 105. As one example, the method can further process the furnace by conducting the step of servicing the furnace, for example by a service technician 2201. The furnace may be serviced by repairing the furnace, reconstructing the furnace, replacing the furnace, conducting routine maintenance or conducting other servicing techniques.

In further examples, the method of processing the furnace 105 may include moving the furnace after assembling the furnace at a location that is outside of the footprint 217. For instance, the furnace 105 can be originally assembled as a new furnace at a location (e.g., the location 2101) that is outside of the footprint 217. Alternatively, the method may include moving the furnace after servicing a used furnace, such as repairing a used furnace, reconstructing the used furnace, replacing the used furnace, conducting routine maintenance or conducting other servicing techniques on the used furnace at a location (e.g., the location 2101) outside of the footprint 217. In such examples, after assembling the new furnace or servicing the used furnace, the method may further include processing the furnace by moving the furnace to be eventually placed on the support structure (see 203 in FIG. 2) as is schematically illustrated by arrow 159 in FIG. 1. In some examples, the method of mounting can involve reversing the order of at least some or all of the steps discussed above.

In one example, with initial reference to FIG. 22, after servicing or assembling, the method may include the step of placing the above referenced pneumatic jacks (not shown in FIG. 22) within the spaces 2203. As shown in FIG. 21, the pneumatic jacks 225 can be inflated to lift the furnace 105. The fluid support bearings 1005a,b, 1007a,b, 1009a,b, and 1011a,b may then be placed under the respective feet 207 of the base 201.

As shown in FIG. 20, the fluid support bearings may then be activated to lift the furnace 105 and support the furnace on the fluid cushion 2001 while moving the furnace to a location outside of the footprint 217 as shown in FIG. 19. As further shown in FIG. 18, the method can further include the step of lifting the furnace 105 with the pneumatic jacks 225 to insert the support members 1001a, 1001b, 1001c, 1001d under the respective feet 207 of the base with the fluid support bearings 1005a,b, 1007a,b, 1009a,b, and 1011a,b underneath respective first and second end portions 1201, 1203 of the support members. As shown in FIG. 17, the pneumatic jacks 225 can be deflated such that the weight of the furnace 105 is supported by the support members 1001a, 1001b, 1001c, 1001d.

The method of processing the furnace can therefore, in one example, at least include the step of supporting the furnace 105 (in the position outside of the footprint 217 shown in FIGS. 16 and 17) with a support member (e.g., support members 1001a, 1001b, 1001c, 1001d) that is configured to span across and beyond the footprint 217 of the mounting area 205. Furthermore, in the position shown in FIGS. 16 and 17, the support surface 221 outside of the footprint 217 is configured to support the opposite end portions 1201, 1203 of the support members 1001a, 1001b, 1001c, 1001d such that the furnace 105 may be subsequently suspended over the mounting area 205.

The method can further include the step of levitating the opposite end portions 1201, 1203 of the support members 1001a, 1001b, 1001c, 1001d over the support surface 221 on the cushion of fluid (e.g., cushion of air 1501). The method can also include the step of moving the furnace 105 together with the support member relative to the support surface 221 while the opposite end portions 1201, 1203 of the support member are levitated over the support surface 221 with the cushion of fluid 1501. The step of moving includes moving the furnace from the position outside of the footprint (e.g., See FIGS. 16 and 17) to a position within the footprint 217 (i.e., within the vertical projection of the footprint 217) such that the furnace 105 is suspended over the mounting area 205 as shown in FIGS. 12 and 13.

In one example, the method of moving the furnace 105 to the position within the footprint can include moving the furnace by guiding the furnace along a predetermined path. For instance, as discussed above, the method can include guiding the support members 1001a, 1001b, 1001c, 1001d with the guide rails 1607a, 1607b. Guiding the furnace along the predetermined path can be beneficial to help align the base 201 with the footprint 217 of the mounting area 205.

The method can further include the step of removing the support member (e.g., support members 1001a, 1001b, 1001c, 1001d) and then placing the furnace 105 on a support structure 203 within the mounting area 205. In one example, the step of removing the support member can comprise lifting the furnace off the support member. Various lifting techniques may be employed. For example, any of the lifting techniques used to lift the furnace off the support structure 203 discussed above can likewise be used to lift the furnace off the support member. For example, the step of lifting can include lifting the furnace 105 with a jack (e.g., a pneumatic jack) and/or a jack in combination with spacers as shown in FIG. 10.

In further examples, placing the furnace on the support structure 203 can include lowering the furnace 105 to the support structure. In one example, lowering the furnace can comprise lifting the furnace with a jack (e.g., pneumatic jack), removing a set of elevation spacers, and lowering the furnace with the jack (e.g., pneumatic jack) as can be appreciated, for example, by conducting the method steps of FIGS. 2-10 in reverse order.

Referring to FIG. 2, the furnace can comprise a glass melting furnace and the method can include the further steps of operably connecting the glass melting furnace to the downstream glass manufacturing apparatus 153 and/or operably connecting the glass melting furnace to the upstream glass manufacturing apparatus 151 after placing the furnace on the support structure. Indeed, as shown in FIG. 2, the batch delivery device 111 may be connected to the furnace 105 to engage the upstream glass manufacturing apparatus 151 with the furnace 105. As further shown, the first connecting conduit 129 may be connected to the furnace 105 to engage the downstream glass manufacturing apparatus 153 from the furnace 105.

Various methods of processing the furnace as discussed above can also include the step of operating the furnace (e.g., using the furnace to heat gases, liquids and/or solids), or other processing techniques. Indeed, as described with reference to FIG. 1 above, the methods of processing a glass melting furnace can include using the furnace to heat batch material to create the glass melt 121 that is eventually drawn into the glass ribbon 103 and separated into the glass sheets 104.

It will be apparent to those skilled in the art that various modifications and variations can be made to the present disclosure without departing from the spirit and scope of the invention. Thus, it is intended that the present invention cover the modifications and variations of this disclosure provided they come within the scope of the appended claims and their equivalents.

What is claimed is:

1. A method of processing a furnace comprising the steps of:
(I) supporting the furnace with a support member configured to span across and beyond a footprint of a mounting area, wherein a support surface outside of the footprint is configured to support at least one pair of opposite end portions of the support member such that the furnace is suspended over the mounting area;
(II) supporting the opposite end portions of the support member over the support surface; and
(III) moving the furnace together with the support member relative to the support surface while the opposite end portions of the support member are supported.

2. The method of claim 1, wherein step (II) comprises levitating the opposite end portions of the support member over the support surface on a cushion of fluid.

3. The method of claim 2, wherein step (III) comprises moving the furnace while the opposite end portions of the support member are levitated over the support surface with the cushion of fluid.

4. The method of claim 1, wherein during step (I), the furnace is positioned within the footprint such that the furnace is suspended over the mounting area.

5. The method of claim 4, wherein step (III) moves the furnace to a position outside of the footprint.

6. The method of claim 5, wherein after step (III), further comprising the step of removing the support member.

7. The method of claim 6, wherein the step of removing the support member includes the steps of lifting the furnace off the support member.

8. The method of claim 4, wherein after step (III), further comprising the step of servicing the furnace.

9. The method of claim 1, wherein step (III) comprises moving the furnace from a position outside the footprint to a position within the footprint such that the furnace is suspended over the mounting area.

10. The method of claim 9, wherein after step (III), further comprising the step of removing the support member and then placing the furnace on a support structure within the mounting area.

11. The method of claim 10, wherein the furnace comprises a glass melting furnace and the method further comprises the step of operably connecting the glass melting furnace to a downstream glass manufacturing apparatus after placing the furnace on the support structure.

12. The method of claim 10, wherein the step of removing the support member comprises lifting the furnace off the support member.

13. The method of claim 10, wherein the step of placing the furnace includes lowering the furnace to the support structure.

14. The method of claim 12, wherein the step of lowering the furnace includes the steps of lifting the furnace with a jack, removing a set of elevation spacers, and lowering the furnace with the jack.

15. The method of claim 9, wherein the furnace is assembled at a location outside the footprint.

16. The method of claim 9, wherein the furnace is serviced at a location outside the footprint.

17. The method of claim 1, wherein step (III) moves the furnace by guiding the furnace along a predetermined path.

18. The method of claim 17, wherein step (III) includes guiding the support member along the predetermined path with a guide rail.

19. The method of claim 2, wherein the cushion of fluid comprises a cushion of air.
